(19) United States
(12) Patent Application Publication
(10) Pub. No.: US 2026/0274358 A1
(43) Pub. Date: Sep. 17, 2026

(54) SKID STRUCTURE

(71) Applicant: Ford Global Technologies, LLC, Dearborn, MI (US)

(72) Inventors: Thomas Chae, Canton, MI (US); Jose Carlos Ruiz Gutierrez, Commerce Township, MI (US)

(73) Assignee: Ford Global Technologies, LLC, Dearborn, MI (US)

(21) Appl. No.: 19/078,883

(22) Filed: Mar. 13, 2025

(51) Int. Cl. B62D 65/02

(52) U.S. Cl. CPC B62D 65/026

(57) ABSTRACT

A skid structure includes a mini skid and a support structure. The mini skid is configured to be removably coupled to a main skid. The mini skid includes a pair of opposed longitudinal rails and a plurality of beams extending in a transverse direction relative to the main skid and coupling the pair of opposed longitudinal rails. The support structure is secured to the mini skid and is configured to support a plurality of vehicle components. The support structure includes first mounting features configured to support a first vehicle component of the plurality of vehicle components and second mounting features configured to support a second vehicle component of the plurality of vehicle components.

### FIELD

The present disclosure relates to a skid structure for a vehicle.

### BACKGROUND

The statements in this section merely provide background information related to the present disclosure and may not constitute prior art.

Conventional vehicle assembly processes are typically linear processes that involves sequential build of a vehicle body structure referred to as Body in White, followed by painting the body structure, and then securing vehicle components such as a power train assembly, suspension assemblies, and an instrument panel assembly, for example, to a vehicle structure (e.g., uni-body structure) as the vehicle structure moves along an assembly line. Such linear processes may increase assembly time due to restricted access to the vehicle structure at different points along the assembly line.

The present disclosure addresses these issues related to the linear assembly process among other issues as the vehicle structure moves along the assembly line.

### SUMMARY

This section provides a general summary of the disclosure and is not a comprehensive disclosure of its full scope or all of its features.

In one form, the present disclosure provides a skid structure that includes a mini skid and a support structure. The mini skid is configured to be removably coupled to a main skid. The mini skid includes a pair of opposed longitudinal first rails and a plurality of beams extending in a transverse direction relative to the main skid and coupling the pair of opposed longitudinal first rails. The support structure is secured to the mini skid and is configured to support a plurality of vehicle components. The support structure includes first mounting features configured to support a first vehicle component of the plurality of vehicle components and second mounting features configured to support a second vehicle component of the plurality of vehicle components.

In variations of the skid structure of the above paragraph, which can be implemented individually or in any combination: the support structure includes a plurality of vertical posts and a plurality of horizontal posts secured to each other; one or more of the first mounting features extend from a respective horizontal post of the plurality of horizontal posts and one or more first mounting features extend from a respective vertical post of the plurality of vertical posts; one or more second mounting features extend from a respective horizontal post of the plurality of horizontal posts and one or more second mounting features extending from a respective vertical post of the plurality of vertical posts; further including the main skid, the main skid includes a pair of opposed longitudinal second rails extending parallel to the pair of opposed longitudinal first rails; the support structure is secured directly to the pair of opposed longitudinal first rails of the mini skid; the first mounting features comprise apertures; the second mounting features comprise a combination of apertures and pins; and further including the first vehicle component and the second vehicle component, the first vehicle component is a hood panel and the second vehicle component is a fender panel.

In one form, the present disclosure provides a skid structure that includes a main skid, a mini skid and a support structure. The main skid includes a pair of opposed longitudinal first rails and is configured to support a vehicle frame. The mini skid is removably coupled to the main skid. The mini skid includes a pair of opposed longitudinal second rails and a plurality of beams extending in a transverse direction of the main skid. The pair of opposed longitudinal second rails extend along a length of the pair of opposed longitudinal first rails and are mounted onto the pair of opposed longitudinal first rails of the main skid. The support structure is secured to the mini skid and is configured to support a plurality of vehicle components. The support structure includes first mounting features configured to support a first vehicle component of the plurality of vehicle components and second mounting features configured to support a second vehicle component of the plurality of vehicle components.

In variations of the skid structure of the above paragraph, which can be implemented individually or in any combination: the support structure includes a plurality of vertical posts and a plurality of horizontal posts secured to each other; one or more of the first mounting features extend from a respective horizontal post of the plurality of horizontal posts and one or more first mounting features extend from a respective vertical post of the plurality of vertical posts; one or more second mounting features extend from a respective horizontal post of the plurality of horizontal posts and one or more second mounting features extending from a respective vertical post of the plurality of vertical posts; ca plurality of locking features coupled to the main skid and operable between a locked position in which the mini skid is movable relative to the main skid and an unlocked position in which the mini skid in inhibited from moving relative to the main skid in a vertical direction; the plurality of locking features include first and second locking features, the first locking feature is configured to engage a first beam of the plurality of beams when the first locking feature is in the locked position and the second locking feature is configured to engage a second beam of the plurality of beams when the second locking feature is in the locked position; each first rail of the pair of opposed longitudinal first rails includes an alignment feature that engages the mini skid to align the mini skid relative to the main skid; the first mounting features comprise apertures; the second mounting features comprise a combination of apertures and pins; and the skid structure further includes another support structure mounted to the main skid and configured to support the vehicle frame separate from the mini skid.

In one form, the present disclosure provides a skid structure that includes a main skid, a mini skid, a plurality of locking features, a first support structure and a second support structure. The main skid includes a pair of opposed longitudinal first rails. The mini skid is removably mounted onto the pair of opposed longitudinal first rails of the main skid. The mini skid includes a pair of opposed longitudinal second rails and a plurality of beams extending in a transverse direction of the main skid. The pair of opposed longitudinal second rails extend along a length of the pair of opposed longitudinal first rails. The plurality of locking features are coupled to the main skid and operable between a locked position in which the mini skid is movable relative to the main skid and an unlocked position in which the mini skid in inhibited from moving relative to the main skid. The first support structure is secured to the mini skid and is configured to support a plurality of vehicle components. The first support structure includes first mounting features, second mounting features, and posts. The first mounting features are configured to support a first vehicle component of the plurality of vehicle components. The second mounting features are configured to support a second vehicle component of the plurality of vehicle components. The posts include a plurality of vertical posts and a plurality of horizontal posts secured to each other. The second support structure mounted to the main skid and configured to support a vehicle frame separate from the mini skid. The first mounting features comprise apertures and the second mounting features comprise a combination of apertures and pins.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a skid structure according to the present disclosure with vehicle components coupled thereto;

FIG. 2 is a perspective view of the skid structure of FIG. 1 with some vehicle components removed for clarity;

FIG. 3 is a perspective view of the skid structure of FIG. 1;

FIG. 4 is a perspective view of the skid structure of FIG. 1 with a mini skid of the skid structure exploded from a main skid of the skid structure;

FIG. 5 is an enlarged perspective view of the main skid of the skid s structure of FIG. 1;

FIG. 6 is a perspective view of the mini skid and a support structure of the skid structure of FIG. 1; and

FIG. 7 is another perspective view of the mini skid and a support structure of the skid structure of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

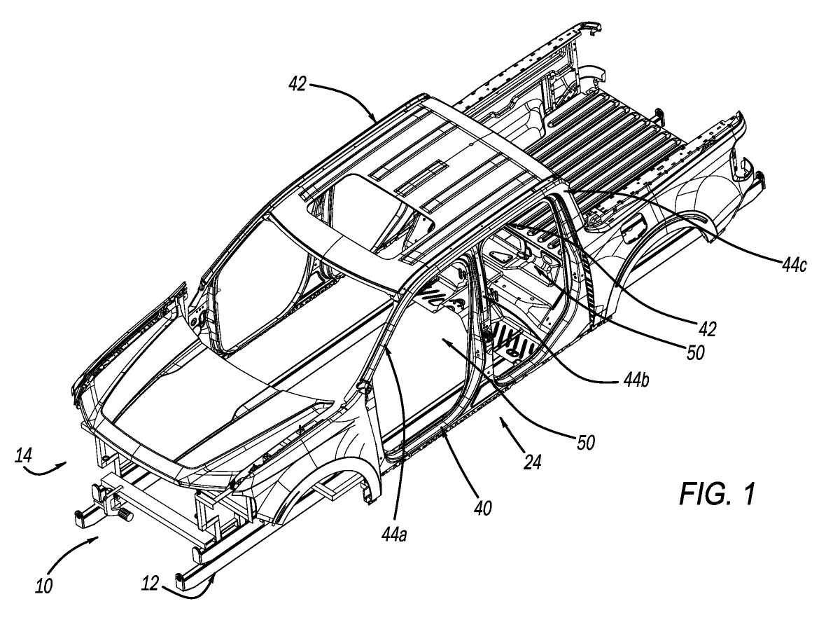

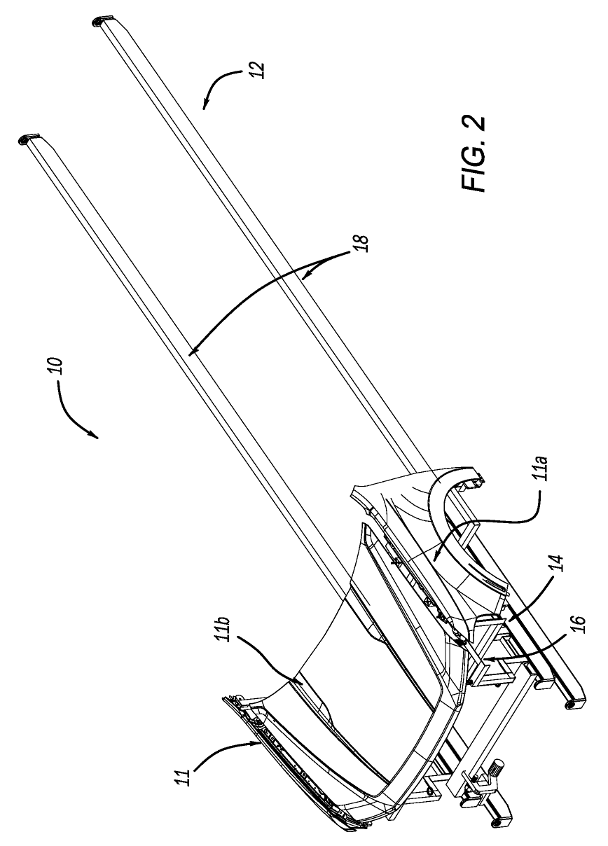

With reference to FIGS. 1 and 2, a skid structure 10 for a vehicle is illustrated. The skid structure 10 may support a plurality of vehicle components 11 as the vehicle components 11 undergo processing. For example, the skid structure 10 may independently support fenders, hoods, and/or a vehicle frame, for example, as the parts are painted in a paint chamber (not shown). In this way, the parts may be removed from the skid structure 10 independently of each other and moved to another station for further processing. In one form, the skid structure 10 may be located on a conveyor (not shown) that moves the skid structure 10 (and the parts coupled to the skid structure 10) between various stations for processing.

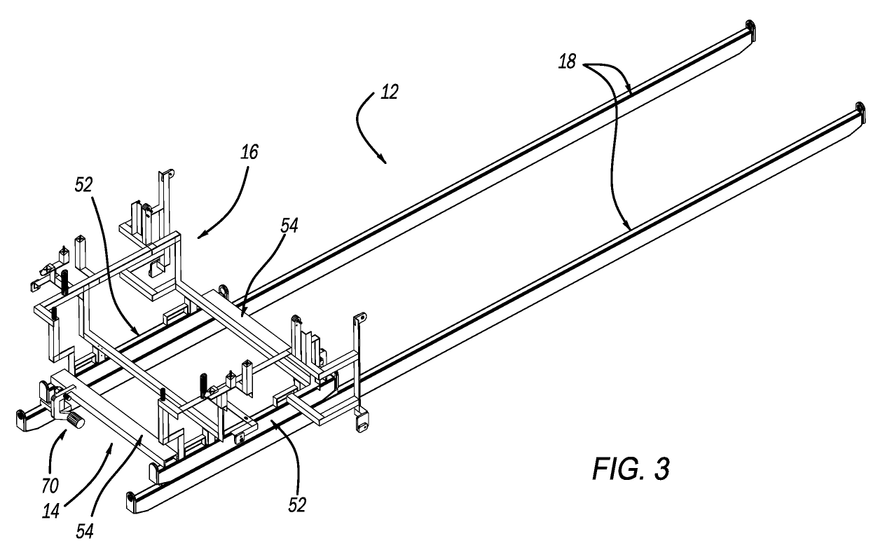

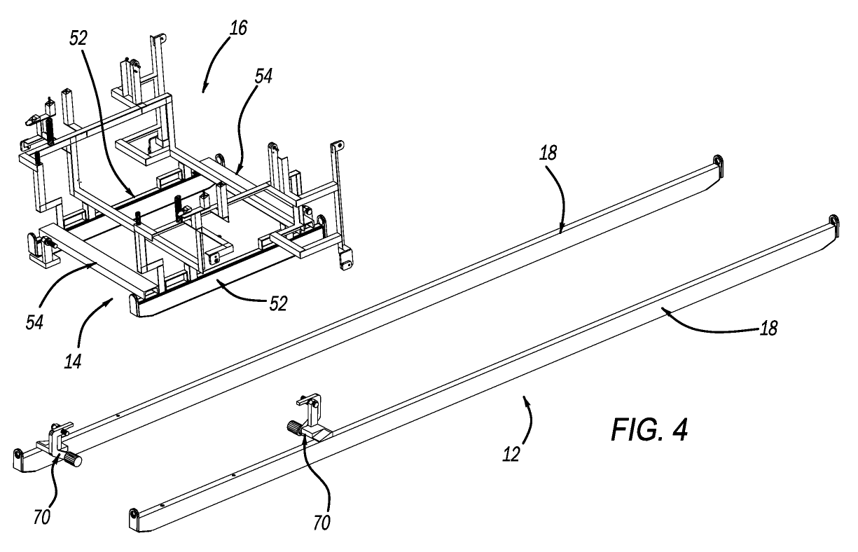

With additional reference to FIGS. 3 and 4, the skid structure 10 includes a main skid 12, a mini skid 14, a support structure 16. The main skid 12 extends a length of the skid structure 10 and includes a pair of opposed longitudinal rails 18 that support the mini skid 14 and various vehicle components thereon. In the example illustrated, the pair of opposed longitudinal rails 18 are spaced apart from each other and include a rectangular cross-section. In other forms, the pair of opposed longitudinal rails 18 may include a square cross-section or any suitable shaped cross-section that may support vehicle components thereon. In the example illustrated, the pair of opposed longitudinal rails 18 may be hollow. In other forms, the pair of opposed longitudinal rails 18 may be solid.

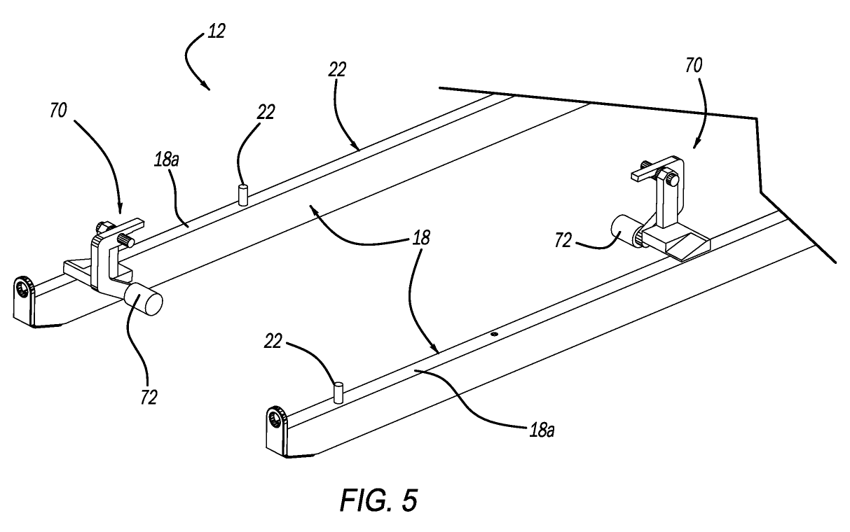

With reference to FIG. 5, the pair of opposed longitudinal rails 18 include one or more first alignment and support features (not shown) and one or more second alignment and support features 22. The first support features align and support a vehicle frame or structure 24 onto the pair of opposed longitudinal rails 18 and the features 22 align and support the mini skid 14 onto the pair of opposed longitudinal rails 18. In the example illustrated, the first support features are located at or near a rear of the pair of opposed longitudinal rails 18 and the features 22 are located at or near a front of the pair of opposed longitudinal rails 18. In some forms, the first support features may be located at or near the front or a middle portion of the pair of opposed longitudinal rails 18 and the features 22 may be located at or near the rear or the middle portion of pair of the opposed longitudinal rails 18. In the example illustrated, the features 22 are pins that extend upward from an upper, planar surface 18a of the pair of opposed longitudinal rails 18 and are configured to be received in corresponding features of the vehicle frame 24 and the mini skid 14. In other forms, the features 22 may be apertures formed in the upper surface 18a or any other suitable features that may align and support the vehicle frame 24 and the mini skid 14 on the pair of opposed longitudinal rails 18.

With reference to FIG. 1, the vehicle structure 24 may be a rear vehicle structure, for example, and may be removably coupled to the main skid 12 independently of the mini skid 14. That is, the first support features (not shown) may facilitate alignment and support of the vehicle structure 24 onto the main skid 12 independently of the mini skid 14 (and support structure 16). In the example illustrated, the vehicle structure 24 includes rockers 40, upper side rails 42, and a plurality of pillars (e.g., a pair of front pillars 44a, a pair of middle pillars 44b, a pair of rear pillars 44c and a pair of hinge pillars). The rockers 40 extend lengthwise in a longitudinal direction of the skid structure 10. Each rocker 40 is made of a metal material such as aluminum, for example.

Each upper side rail 42 is positioned at a side of the vehicle structure 24 and extends along the longitudinal direction of the skid structure 10. Each upper side rail 42 includes one or more structural members extending along the longitudinal direction of the vehicle structure 24. Each front pillar 44a extends in the longitudinal direction of the vehicle structure 24 from a respective upper side rail 42 to a respective hinge pillar. Each middle pillar 44b extends in a vertical direction from a respective upper side rail 42 to a respective rocker 40. Each rear pillar 44c extends toward a rear of the vehicle structure 24 from an end of a respective upper side rail 42. The front pillars 44a, the middle pillars 44b, the hinge pillars, the rockers 40 and the upper side rails 42 cooperate to define door openings 50 in the vehicle structure 24. Doors (not shown) are rotatably coupled to the vehicle structure 24 and may be rotatable between a closed position in which the doors are disposed within the door openings 50 and an open position in which the doors are removed from the door openings 50. Each hinge pillar extends in a vertical direction from an end of a respective front pillar 44a to an end of a respective rocker 40.

The mini skid 14 is removably coupled to the pair of opposed longitudinal rails 18 of the main skid 12 and is secured to the support structure 16. In the example illustrated, the mini skid 14 is mounted onto the upper surface 18a of the pair of opposed longitudinal rails 18. The mini skid 14 is configured to independently support vehicle components 11 separate from the main skid 12. In this way, the mini skid 14 (and vehicle components 11 coupled thereto) may be decoupled from the main skid 12 and moved to another workstation for further processing independently of the vehicle structure 24 coupled to the main skid 12.

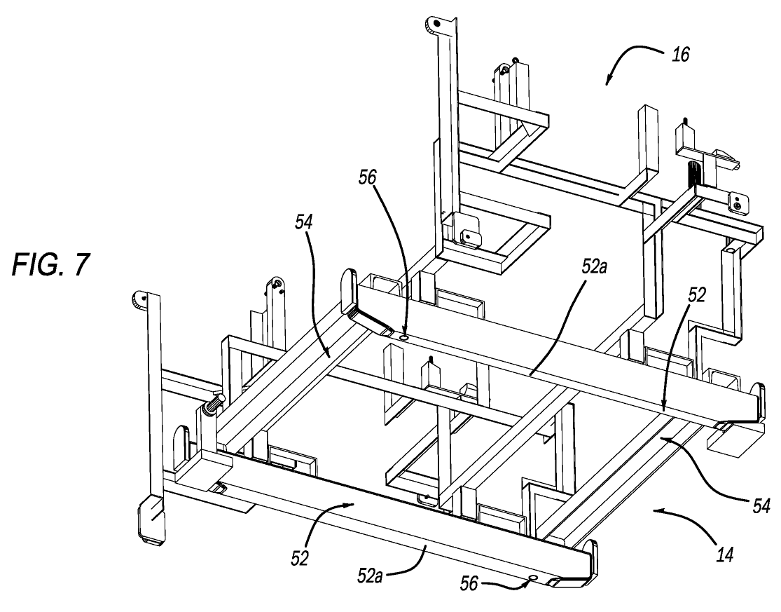

With reference to FIGS. 3, 4, 6, and 7, the mini skid 14 includes a pair of opposed longitudinal rails 52 and a plurality of beams 54 extending in a traverse direction relative to the main skid 12. Each rail 52 of the pair of opposed longitudinal rails 52 is coupled to a respective rail 18 (i.e., mounted onto the upper, planar surface 18a of the respective rail 18) and extends parallel to the respective rail 18. Each rail 52 includes one or more alignment features 56 (FIG. 7) located at a lower surface 52a of the rail 52. In this example illustrated, the alignment features 56 may cooperate with the alignment features 22 of the rail 18 to align and couple the rails 18, 52 to each other. In this way, the mini skid 14 is inhibited from moving in a longitudinal direction and transverse direction of the skid structure 10 when coupled to the rails 18. In the example illustrated, the alignment features 56 are apertures formed in the lower surface 52a that receive the alignment features 20 of the main skid 12. In some forms, the alignment features 56 may be pins extending from the lower surface 52a that are received in apertures of the main skid 12. In the example illustrated, the rails 52 have one or more handles 58 fixed thereto (i.e., fixed to an upper surface 52b of the rail 52), which facilitate gripping and transporting the mini skid 14, for example.

In the example illustrated, the pair of opposed longitudinal rails 52 are spaced apart from each other and include a rectangular cross-section. In other forms, the pair of opposed longitudinal rails 52 may include a square cross-section or any suitable shaped cross-section that may support vehicle components thereon. In the example illustrated, the pair of opposed longitudinal rails 52 may be hollow. In other forms, the pair of opposed longitudinal rails 52 may be solid.

The beams 54 are fixed (e.g., welded) to the rails 52 such that the rails 52 and the beams 54 form a unitized box. In this example illustrated, the beams 54 are spaced apart from each other and secured to ends of the rails 52. In some forms, the mini skid 14 may include additional beams extending in a transverse direction of the main skid 12 and coupling the rails 52 to each other at a middle or central portion of the rails 52. In the example illustrated, the beams 54 are mounted onto the upper surface 52b of the rails 52. In some forms, the beams 54 may be secured to the rails 52 at a location that is between the upper surface 52b and the lower surface 52a of the rails 52. In the example illustrated, the rails 52 include a rectangular cross-section. In other forms, the rails 52 may include a square cross-section or any suitable shaped cross-section that may support vehicle components thereon. In the example illustrated, the rails 52 may be hollow. In other forms, the rails 52 may be solid.

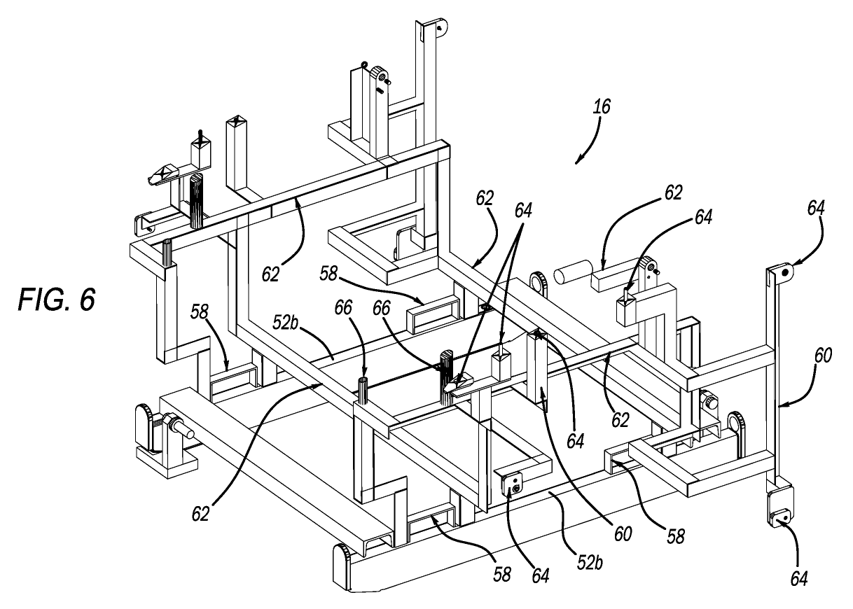

With reference to FIGS. 6 and 7, the support structure 16 is secured to the mini skid 14 and is configured to support the vehicle components 11 as will be described in more detail below. The support structure 16 includes a plurality of vertical posts 60, a plurality of horizontal posts 62, and a plurality of mounting features 64, 66. The vertical posts 60 and the horizontal posts 62 are secured to each other to form a unitized support structure that supports vehicle components 11. Some vertical posts 60 extend upward from a respective rail 52 and some vertical posts 60 extend upward from a respective horizontal post 62. In the example illustrated, the horizontal posts 62 extend in multiple directions. For example, some horizontal posts 62 extend along a longitudinal direction of the main skid 12 and some horizontal posts 62 extend in a transverse direction of the main skid 12. Some horizontal posts 62 may be located outboard or outside of the rails 18 and some horizontal posts 62 may be located between the beams 54.

The mounting features 64 are located on a respective post 60, 62 and are configured to facilitate mounting a vehicle component 11a to the support structure 16. In the example illustrated, some mounting features 64 may be located at an outermost side of the support structure 16 and some mounting features 64 may be located closer towards a center of the support structure 16. The mounting features 64 include apertures and/or pins. In this way, the vehicle component 11a may be mounted to and aligned onto the support structure 16 via the mounting features 64 and fasteners (not shown). In the example illustrated, the vehicle component 11a is a fender (FIGS. 1 and 2).

The mounting features 66 are located on a respective post 60, 62 and are configured to facilitate mounting a vehicle component 11b to the support structure 16. In the example illustrated, the mounting features 66 are located between the mounting features 64 and include apertures and/or pins. In this way, the vehicle component 11b may be mounted to and aligned onto the support structure 16 via the mounting features 64. In the example illustrated, the vehicle component 11b is a hood panel.

With reference to FIGS. 3 and 5, the skid structure 10 further includes a plurality of locking structures or features 70 secured to the main skid 12 and operable (or movable) between an unlocked position in which the mini skid 14 is movable relative to the main skid 12 and a locked position (FIGS. 3 and 5) in which the mini skid 14 is inhibited from moving relative to the main skid 12. For example, when the locking features 70 are in the unlocked position, the mini skid 14 is movable in the vertical direction and horizontal direction relative to the main skid 12. When the locking features 70 are in the locked position, the mini skid 14 is inhibited from moving in the vertical direction and horizontal direction relative to the main skid 12. In the example illustrated, each locking feature 70 is configured to engage a respective beam 54 of the mini skid 14 when in the locked position to inhibit the mini skid 12 from moving in the vertical direction and horizontal direction relative to the main skid 12. When the locking feature 70 is moved to the unlocked position, the locking feature 70 is disengaged from the respective beam 54, thereby allowing the mini skid 14 to move relative to the main skid 12. In the example illustrated, each locking feature 70 includes a weight that biases the locking feature 70 toward the locked position. In some forms, the locking feature may be a hydraulic or electrical locking feature or actuator that may selectively permit motion of the mini skid 12 relative to the main skid 14. An actuator (not shown) such as a mechanical actuator may move the locking feature 70 from the locked position toward the unlocked position such that the mini skid 14 is movable relative to the main skid 12.

It should be understood that additional locking features (not shown) may be secured to the main skid 12 and configured to engage the vehicle structure 24. In this way, when the locking features are in the locked position, the vehicle structure 24 is inhibited from moving relative to the main skid 12, and when the locking features are in the unlocked position, the vehicle structure is allowed to move relative to the main skid 12.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A skid structure comprising:
a mini skid configured to be removably coupled to a main skid, the mini skid including a pair of opposed longitudinal first rails and a plurality of beams extending in a transverse direction relative to the main skid and coupling the pair of opposed longitudinal rails; and
a support structure secured to the mini skid and configured to support a plurality of vehicle components, the support structure including first mounting features configured to support a first vehicle component of the plurality of vehicle components and second mounting features configured to support a second vehicle component of the plurality of vehicle components.

2. The skid structure of claim 1, wherein the support structure includes a plurality of vertical posts and a plurality of horizontal posts secured to each other.

3. The skid structure of claim 2, wherein one or more of the first mounting features extend from a respective horizontal post of the plurality of horizontal posts and one or more first mounting features extend from a respective vertical post of the plurality of vertical posts.

4. The skid structure of claim 2, wherein one or more second mounting features extend from a respective horizontal post of the plurality of horizontal posts and one or more second mounting features extending from a respective vertical post of the plurality of vertical posts.

5. The skid structure of claim 1, further comprising the main skid, the main skid including a pair of opposed longitudinal second rails extending parallel to the pair of opposed longitudinal first rails.

6. The skid structure of claim 1, wherein the support structure is secured directly to the pair of opposed longitudinal first rails of the mini skid.

7. The skid structure of claim 1, wherein the first mounting features comprise apertures.

8. The skid structure of claim 7, wherein the second mounting features comprise a combination of apertures and pins.

9. The skid structure of claim 1, further comprising the first vehicle component and the second vehicle component, the first vehicle component is a hood panel and the second vehicle component is a fender panel.

10. A skid structure comprising:
a main skid including a pair of opposed longitudinal first rails and configured to support a vehicle frame;
a mini skid removably coupled to the main skid, the mini skid including a pair of opposed longitudinal second rails and a plurality of beams extending in a transverse direction of the main skid, the pair of opposed longitudinal second rails extending along a length of the pair of opposed longitudinal first rails and mounted onto the pair of opposed longitudinal first rails of the main skid; and
a support structure secured to the mini skid and configured to support a plurality of vehicle components, the support structure including first mounting features configured to support a first vehicle component of the plurality of vehicle components and second mounting features configured to support a second vehicle component of the plurality of vehicle components.

11. The skid structure of claim 10, wherein the support structure includes a plurality of vertical posts and a plurality of horizontal posts secured to each other.

12. The skid structure of claim 11, wherein one or more of the first mounting features extend from a respective horizontal post of the plurality of horizontal posts and one or more first mounting features extend from a respective vertical post of the plurality of vertical posts.

13. The skid structure of claim 11, wherein one or more second mounting features extend from a respective horizontal post of the plurality of horizontal posts and one or more second mounting features extending from a respective vertical post of the plurality of vertical posts.

14. The skid structure of claim 10, further comprising a plurality of locking features coupled to the main skid and operable between a locked position in which the mini skid is movable relative to the main skid and an unlocked position in which the mini skid in inhibited from moving relative to the main skid in a vertical direction.

15. The skid structure of claim 14, wherein the plurality of locking features include first and second locking features, and wherein the first locking feature is configured to engage a first beam of the plurality of beams when the first locking feature is in the locked position and the second locking feature is configured to engage a second beam of the plurality of beams when the second locking feature is in the locked position.

16. The skid structure of claim 10, wherein each first rail of the pair of opposed longitudinal first rails includes an alignment feature that engages the mini skid to align the mini skid relative to the main skid.

17. The skid structure of claim 10, wherein the first mounting features comprise apertures.

18. The skid structure of claim 17, wherein the second mounting features comprise a combination of apertures and pins.

19. The skid structure of claim 10, further comprising another support structure mounted to the main skid and configured to support the vehicle frame separate from the mini skid.

20. A skid structure comprising:
a main skid including a pair of opposed longitudinal first rails;
a mini skid removably mounted onto the pair of opposed longitudinal first rails of the main skid, the mini skid including a pair of opposed longitudinal second rails and a plurality of beams extending in a transverse direction of the main skid, the pair of opposed longitudinal second rails extending along a length of the pair of opposed longitudinal first rails;
a plurality of locking features coupled to the main skid and operable between a locked position in which the mini skid is movable relative to the main skid and an unlocked position in which the mini skid in inhibited from moving relative to the main skid;
a first support structure secured to the mini skid and configured to support a plurality of vehicle components, the first support structure including first mounting features, second mounting features, and posts, the first mounting features configured to support a first vehicle component of the plurality of vehicle components, the second mounting features configured to support a second vehicle component of the plurality of vehicle components, the posts include a plurality of vertical posts and a plurality of horizontal posts secured to each other; and
a second support structure mounted to the main skid and configured to support a vehicle frame separate from the mini skid,
wherein the first mounting features comprise apertures and the second mounting features comprise a combination of apertures and pins.
